(19) United States
(12) Patent Application Publication
(10) Pub. No.: US 2007/0208887 A1
(43) Pub. Date: Sep. 6, 2007

(54) Method, apparatus, and medium for controlling direct memory access

(75) Inventors: Doo-hyun Kim, Yongin-si (KR); Hyun-sang Park, Cheonan-si (KR); Shi-hwa Lee, Yongin-si (KR); Do-hyung Kim, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co, Ltd., Suwon-si (KR)

(21) Appl. No.: 11/706,214

(22) Filed: Feb. 15, 2007

Related U.S. Application Data
(60) Provisional application No. 60/774,202, filed on Feb. 17, 2006.

(30) Foreign Application Priority Data
May 30, 2006 (KR) 10-2006-0049030

(51) Int. Cl. G06F 13/28

(52) U.S. Cl. 710/22

(57) ABSTRACT

Provided are a method, apparatus, and medium for controlling direct memory access (DMA). The apparatus includes a memory which is divided into a plurality of storage areas, a memory controller which is connected to the memory and comprises a plurality of ports, a plurality of DMA controllers which independently control access to data stored in each of the plurality of storage areas, and a plurality of buses which connect the memory controller and each of the plurality of DMA controllers. Using the apparatus, the time required in accessing the data can be remarkably reduced by employing the plurality of DMA controllers in order to perform parallel access to the data stored in each area of the memory.

### CROSS-REFERENCE TO RELATED APPLICATIONS

This application claims the benefit of U.S. Provisional Patent Application No. 60/774,202, filed on Feb. 17, 2006, and the benefit of Korean Patent Application No. 10-2006-0049030, filed on May 30, 2006, in the Korean Intellectual Property Office, the disclosure of which is incorporated herein in its entirety by reference.

### BACKGROUND OF THE INVENTION

1. Field of the Invention

The present invention relates to memory access control, and more particularly, to a method, apparatus, and medium for controlling direct memory access (DMA) having improved access efficiency.

2. Description of the Related Art

Direct memory access (DMA) allows direct data transmission between a memory and an input/output device without using a central processing unit (CPU). DMA is used in transmitting a massive amount of data since data can be transmitted quickly. DMA processes include a CPU outputting a command to a DMA controller and selecting a required parameter; the DMA controller outputting a data access request signal to a memory controller which controls input/output to and from a memory; the memory controller accessing data; and the DMA controller outputting a termination signal to the CPU when access to all data is complete.

The DMA controller operates as a master and the memory controller operates as a slave. However, when a single DMA controller outputs a data access request signal to the memory controller, the single DMA controller cannot output another data access request signal until a response signal to the data access request signal is received from the memory controller. Also, the memory controller cannot transmit a plurality of response signals to the DMA controller. Accordingly, too much time has passed when the DMA controller accesses data individually stored in predetermined areas of the memory, because the accessing process is performed sequentially. Specifically during coding and decoding of image data, the coding and decoding cannot be performed within a predetermined time, when access requests for image data divided into small sizes are frequently generated, due to a bandwidth problem.

### SUMMARY OF THE INVENTION

Additional aspects, features, and/or advantages of the invention will be set forth in part in the description which follows and, in part, will be apparent from the description, or may be learned by practice of the invention.

The present invention provides a method, apparatus, and medium for controlling direct memory access (DMA), which employ a plurality of direct memory access controllers in order to perform parallel access on data stored in each area of a memory.

According to an aspect of the present invention, there is provided an apparatus for controlling direct memory access (DMA), including: a memory which is divided into a plurality of storage areas; a memory controller which is connected to the memory and comprises a plurality of ports; a plurality of DMA controllers which independently control access to data stored in each of the plurality of storage areas; and a plurality of buses which connects the memory controller and each of the plurality of DMA controllers.

According to another aspect of the present invention, there is provided a method of controlling DMA using the apparatus for controlling DMA described above, the method including: the plurality of DMA controllers outputting access request signals for data individually stored in the plurality of storage areas of the memory to the memory controller through buses; and the memory controller independently accessing the data from each of the plurality of storage areas of the memory in response to each of the access request signals.

According to another aspect of the present invention, there is provided an apparatus for controlling direct memory access (DMA), including a memory which is divided into a plurality of storage areas; a memory controller which is connected to the memory; a plurality of DMA controllers which independently control access to data stored in each of the plurality of storage areas; and a plurality of buses which connects the memory controller and each of the plurality of DMA controllers.

According to another aspect of the present invention, there is provided a method for accessing data including outputting from a plurality of direct memory access (DMA) controllers to a memory controller access request signals for data individually stored in the plurality of storage areas of the memory; and accessing independently the data from each of the plurality of storage areas of the memory in response to each of the access request signals, wherein the memory controller independently accesses the data.

According to another aspect of the present invention, there is provided an apparatus for controlling direct memory access (DMA), including a memory which is divided into a plurality of storage areas; a memory controller which is connected to the memory; a plurality of DMA controllers which independently control access to data stored in each of the plurality of storage areas, wherein each DMA controller independently controls the memory controller to access data in the plurality of storage areas.

According to another aspect of the present invention, there is provided at least one computer readable medium storing computer readable instructions to implement methods of the present invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus for controlling direct memory access (DMA) according to an exemplary embodiment of the present invention;

FIG. 2 is a diagram for describing the time required to access data using a plurality of direct memory access controllers according to an exemplary embodiment of the present invention; and

FIG. 3 is a flowchart illustrating a method of controlling direct memory access according to an exemplary embodiment of the present invention.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

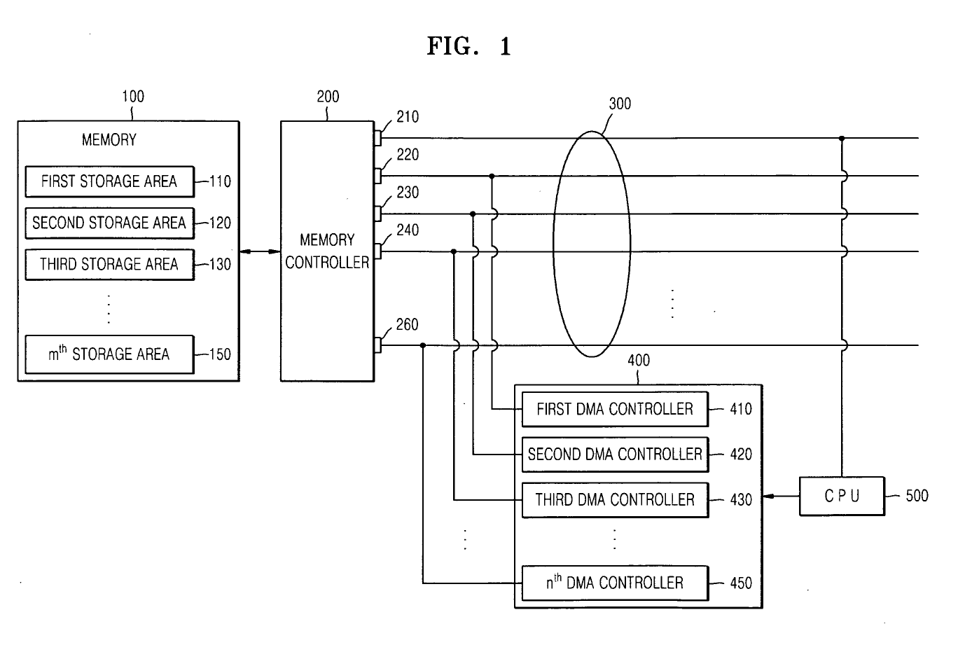

FIG. 1 is a block diagram illustrating an apparatus for controlling direct memory access (DMA) according to an exemplary embodiment of the present invention. The apparatus includes a memory 100, a memory controller 200, a plurality of buses 300, a plurality of DMA controllers 400, and a central processing unit (CPU) 500.

The memory 100 is divided into a plurality of storage areas. As shown in FIG. 1, the plurality of storage areas are divided into a first storage area through to a m^{th} storage area 110, 120, 130, through to 150. Generally, each of the first storage area through to the m^{th} storage area 110, 120, 130, through to 150 is referred to as a bank.

The memory 100 stores image data in each of the plurality of storage areas by classifying the image data according to lines. The image data is two-dimensional data having a size given by a width in pixel numbers×a length in pixel numbers based on a frame unit. The data in each line of the two-dimensional data is alternately stored in the plurality of storage areas. For example, when the image data is stored in the first storage area through to the m^{th} storage area 110, 120, 130, through to 150, data in a first line is stored in the first storage area 110, data in a second line is stored in the second storage area 120, data in a third line is stored in the third storage area 130, and data in a m^{th} line is stored in the m^{th} storage area 150. Then, data in a m+1^{th} line is again stored in the first storing unit 110, data in a m+2^{th} line is again stored in the second storing unit 120, data in a m+3^{th} line is again stored in the third storing unit 130, and data in a m+m^{th} line is again stored in the m^{th} storing unit 150.

On the other hand, the memory 100 stores the image data in each of the plurality of storage areas by classifying the image data according to odd lines and even lines. For example, each line of the image data is classified into odd lines and even lines, and data in odd lines is stored in the first storage area 110 and data in even lines is stored in the second storage area 120.

The memory controller 200 is connected to the memory 100 and includes a plurality of ports. The memory controller 200 accesses data stored in the plurality of storage areas of the memory 100 in response to access request signals from the plurality of DMA controllers 400. In order to receive each of the access request signals from the plurality of DMA controllers 400, the memory controller 200 includes a plurality of ports 210, 220, 230, 240, through to 260.

The plurality of buses 300 are connected to each of the ports 210, 220, 230, 240, through to 260 of the memory controller 200, and are also connected to each of the plurality of DMA controllers 400.

The CPU 500 outputs a control signal to the plurality of DMA controllers 400 in order to access data stored in the memory 100.

In response to the control signal from the CPU 500, the plurality of DMA controllers 400 independently control access to data individually stored in the plurality of storage areas. As shown in FIG. 1, the plurality of DMA controllers 400 includes first through n^{th} DMA controllers 410, 420, 430, through to 450. The first DMA controller 410 is connected to the memory controller 200 by one bus from among the plurality of buses 300, the second DMA controller 420 is connected to the memory controller 200 by another bus from among the plurality of buses 300, the third DMA controller 430 is connected to the memory controller 200 by another bus from among the plurality of buses 300, and the n^{th} DMA controller 450 is connected to the memory controller 200 by another bus from among the plurality of buses 300.

Since the plurality of DMA controllers 400 are each connected to the memory controller 200 by separate buses, access request signals can be outputted to the memory controller 200 simultaneously. For example, when the first DMA controller 410 outputs a first access request signal in order to access data stored in the first storage area 110 of the memory 100, the second DMA controller 420 can output a second access request signal in order to access data stored in the second storage area 120 of the memory 100 simultaneously, the third DMA controller 430 can output a third access request signal in order to access data stored in the third storage area 130 of the memory 100 simultaneously, and the n^{th} DMA controller 450 can output a n^{th} access request signal in order to access data stored in the n^{th} storage area (not shown) of the memory 100 simultaneously.

The memory controller 200 simultaneously accesses data individually stored in the plurality of storage areas 110, 120,130, through to 150 in response to each access request signal received from the plurality of DMA controllers 400. The memory controller 200 accesses the data individually stored in each storage areas 110,120, 130, through to 150 of the memory 100 in parallel. Accordingly, time required to access data can be remarkably reduced.

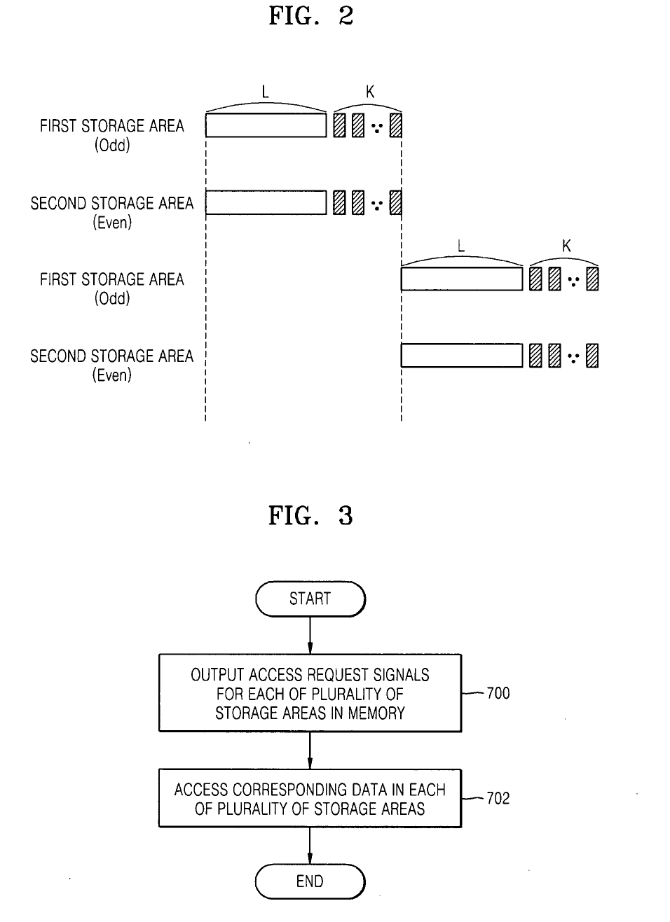

FIG. 2 is a diagram for describing the time required to access data using the plurality of DMA controllers 400 shown in FIG. 1 according to an exemplary embodiment of the present invention. In the first storage area 110, data in odd lines from among the image data is stored and in the second storage area 120, data in even lines from among the image data is stored. When the first DMA controller 410 requests access to data stored in the first storage area 110 and the second DMA controller 420 requests access to data stored in the second storage area 120, the memory controller 200 independently accesses data stored in the first storage area 110 and data stored in the second storage area 120 in response to access request signals from the first DMA controller 410 and the second DMA controller 420. The time required to access data in the first line stored in the first storage area 110 is L+K. Here, L is the time required to access the line and K is the time required to access the stored data itself. On the other hand, while the data in the first line stored in the first storage area 110 is being accessed, data in the second line stored in the second storage area 120 is independently accessed. Accordingly, the time required to access the data in the second line stored in the second storage area 120 falls below the time required to access the data in the first line stored in the first storage area 110. Thus, additional time is not required to access the data in the second line. After the data in the first line has been accessed, the time required to access data in the third line stored in the first storage area 110 is likewise L+K. Also, while the data in the third line stored in the first storage area 110 is being accessed, data in the fourth line stored in the second storage area 120 is independently accessed. Accordingly, the time required to access the data in the fourth line stored in the second storage area 120 falls below the time required to access the data in the third line stored in the first storage area 110. Thus, additional time is not required to access the data in the fourth line. Subsequently, the time required to access data can be reduced by half, by employing the first DMA controller 410 and the second DMA controller 420 in order to independently access data stored in each storage area of the memory 100 using the plurality of DMA controllers 410 and 420.

Table 1 shows DMA speed in a conventional apparatus for controlling DMA and the apparatus for controlling DMA of an exemplary embodiment of the present invention. Table 1 compares the time required to access data in an m^{th} line when the first and second DMA controllers 410 and 420 are used in the apparatus of the present exemplary embodiment.

TABLE 1

| | Time required |
|---|---|
| Conventional | (L + K) × M |
| apparatus | |
| Apparatus of the | (L + K) × M/2 |
| present invention | |

In the conventional apparatus, the data in the m^{th} line is accessed using one DMA controller, and thus a time of (L+K)×M is required. However, in the apparatus of the present exemplary embodiment, two DMA controllers are used which access in parallel data individually stored in different areas of a memory. Accordingly, a time of (L+K)×M/2 is required.

The apparatus for controlling DMA described above may be embodied in one chip, that is, the apparatus is a system-on-a-chip (SoC). Also, the apparatus is applied in coding and decoding of image data.

Hereinafter, a method of controlling DMA according to an exemplary embodiment of the present invention will be described with reference to FIG. 3.

FIG. 3 is a flowchart illustrating the method of controlling DMA according to the current exemplary embodiment of the present invention, and the method will be described referring to the apparatus for controlling DMA as illustrated in FIG. 1.

When the CPU 500 outputs a control signal to the plurality of DMA controllers 400 in order to access data stored in the memory 100, the plurality of DMA controllers 400 output access request signals to the memory controller 200 through each of the buses 300 in operation 700. The access request signals are access request signals on data individually stored in the plurality of storage areas 110, 120, through to 140 of the memory 100. Since the plurality of DMA controllers 400 are each connected to the memory controller 200 through separate buses, the access request signals can be simultaneously outputted to the memory controller 200.

Next, the memory 200 independently accesses data stored in the plurality of storage areas 110, 120, through to 140 of the memory 100 in response to each of the access request signals in operation 702.

The memory 100 stores image data in each of the plurality of storage areas by classifying the image data according to lines. Specifically, the memory 100 stores the image data in each of the plurality of storage areas by classifying the image data according to odd lines and even lines.

When each of the plurality of DMA controllers 400 simultaneously outputs the access request signals to the memory controller 200, the memory controller 200 simultaneously accesses data in each of the plurality of storage areas in response to the received access request signals. The time required to access data can be remarkably reduced because the memory controller 200 accesses the data individually stored in each storage area of the memory 100 in parallel.

The method of controlling DMA can be applied in coding and decoding of image data. When access requests for image data divided into small sizes are frequently generated, the method according to the current exemplary embodiment can be used to reduce the time required to access the data, thereby efficiently using a bandwidth.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter. In addition, code/instructions may include functional programs and code segments.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. For example, storage/transmission media may include optical wires/lines, waveguides, and metallic wires/lines, etc. including a carrier wave transmitting signals specifying instructions, data structures, data files, etc. The medium/media may also be a distributed network, so that the computer readable code/instructions are stored/transferred and executed in a distributed fashion. The medium/media may also be the Internet. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments.

The term “module”, as used herein, denotes, but is not limited to, a software component, a hardware component, or a combination of a software component and a hardware component, which performs certain tasks. A module may advantageously be configured to reside on the addressable storage medium/media and configured to execute on one or more processors. Thus, a module may include, by way of example, components, such as software components, application specific software component, object-oriented software components, class components and task components, processes, functions, operations, execution threads, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. Further, the components or modules can operate at least one processor (e.g. central processing unit (CPU)) provided in a device. In addition, examples of a hardware components include an application specific integrated circuit (ASIC) and Field Programmable Gate Array (FPGA). As indicated above, a module can also denote a combination of a software component(s) and a hardware component(s).

The computer readable code/instructions and computer readable medium/media may be those specially designed and constructed for the purposes of the present invention, or they may be of the kind well-known and available to those skilled in the art of computer hardware and/or computer software.

The computer readable code/instructions and computer readable medium/media may be those specially designed and constructed for the purposes of the present invention, or they may be of the kind well-known and available to those skilled in the art of computer hardware and/or computer software.

Using exemplary embodiments of method, apparatus, and medium for controlling DMA according to the present invention, the time required to access the data can be remarkably reduced by employing the plurality of DMA controllers in order to perform parallel access to the data stored in each area of the memory. Also, by minimizing a time for data access using coding and decoding of image data, delay in the coding and decoding due to insufficient bandwidth can be prevented.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An apparatus for controlling direct memory access (DMA), comprising:
a memory which is divided into a plurality of storage areas;
a memory controller which is connected to the memory;
a plurality of DMA controllers which independently control access to data stored in each of the plurality of storage areas; and
a plurality of buses which connects the memory controller and each of the plurality of DMA controllers.

2. The apparatus of claim 1, wherein the data is image data and the memory stores the image data in each of the plurality of storage areas by classifying the image data according to lines.

3. The apparatus of claim 2, wherein the memory stores the image data in each of the plurality of storage areas by classifying the image data according to odd lines and even lines.

4. The apparatus of claim 1, wherein the memory controller simultaneously accesses data stored in each of the plurality of storage areas in response to each received access request signal, when each of the plurality of DMA controllers simultaneously outputs the access request signal to the memory controller.

5. The apparatus of claim 1, embodied in one chip.

6. The apparatus of claim 1, wherein the data is image data and the plurality of DMA controllers independently control access to the image data for coding and decoding of the image data.

7. A method for accessing data comprising:
outputting from a plurality of direct memory access (DMA) controllers to a memory controller access request signals for data individually stored in the plurality of storage areas of the memory; and
accessing independently the data from each of the plurality of storage areas of the memory in response to each of the access request signals,
wherein the memory controller independently accesses the data.

8. The method of claim 7, wherein the data is image data and the memory stores image data in each of the plurality of storage areas by classifying the image data according to lines.

9. The method of claim 8, wherein the memory stores the image data in each of the plurality of storage areas by classifying the image data according to odd lines and even lines.

10. The method of claim 7, wherein the memory controller simultaneously accesses data stored in each of the plurality of storage areas in response to each received access request signal, when each of the plurality of the DMA controllers simultaneously outputs the access request signal to the memory controller.

11. The method of claim 7, wherein the data is image data and the plurality of DMA controllers independently control access to the image data for coding and decoding of the image data.

12. At least one computer readable medium storing computer readable instructions that control at least one processor to implement the method of claim 7.

13. At least one computer readable medium storing computer readable instructions that control at least one processor to implement the method of claim 8.

14. At least one computer readable medium storing computer readable instructions that control at least one processor to implement the method of claim 9.

15. At least one computer readable medium storing computer readable instructions that control at least one processor to implement the method of claim 10.

16. At least one computer readable medium storing computer readable instructions that control at least one processor to implement the method of claim 11.

17. An apparatus for controlling direct memory access (DMA), comprising:
a memory which is divided into a plurality of storage areas;
a memory controller which is connected to the memory;
a plurality of DMA controllers which independently control access to data stored in each of the plurality of storage areas, wherein each DMA controller independently controls the memory controller to access data in the plurality of storage areas.

18. The apparatus of claim 17, wherein the memory controller simultaneously accesses data stored in each of the plurality of storage areas in response to each received access request signal, when each of the plurality of DMA controllers simultaneously outputs the access request signal to the memory controller.

19. The apparatus of claim 17, wherein the data is image data.

20. The apparatus of claim 19, wherein the data is image data and the plurality of DMA controllers independently control access to the image data for coding and decoding of the image data.

21. The apparatus of claim 19, wherein the memory stores image data in each of the plurality of storage areas by classifying the image data according to lines.

22. The apparatus of claim 21, wherein the memory stores the image data in each of the plurality of storage areas by classifying the image data according to odd lines and even lines.

23. The apparatus of claim 21, embodied in one chip.

24. The apparatus of claim 1, wherein the memory controller comprises a plurality of ports.
